(19) United States
(12) Patent Application Publication
(10) Pub. No.: US 2024/0103519 A1
(43) Pub. Date: Mar. 28, 2024

(54) INTELLIGENT ASSIGNMENT OF ROBOTIC EDGE DEVICES IN AN EDGE COMPUTING ECOSYSTEM

(71) Applicant: International Business Machines Corporation, Armonk, NY (US)

(72) Inventors: Atul Mene, Morrisville, NC (US); Martin G. Keen, Cary, NC (US); Tushar Agrawal, West Fargo, ND (US); Sarbajit K. Rakshit, Kolkata (IN); Jeremy R. Fox, Georgetown, TX (US)

(21) Appl. No.: 17/935,956

(22) Filed: Sep. 28, 2022

(51) Int. Cl. G05D 1/02

(52) U.S. Cl. CPC G05D 1/0214; G05B 2219/39001

(57) ABSTRACT

Provided is a computer-implemented method, system, and computer program product for intelligently assigning robotic edge devices to perform a task using an edge computing ecosystem. A processor may identify a plurality of robotic edge devices in a geographic location. The processor may determine attributes for each robotic edge device of the plurality of robotic edge devices. The processor may identify a task to be performed at the geographic location by the plurality of robotic edge devices. The processor may determine, based on the attributes, a subset of robotic edge devices that are capable of completing the task. The processor may assign the subset of robotic edge devices to complete the task.

### BACKGROUND

The present disclosure relates generally to the field of robotic devices and, more specifically, to intelligently assigning robotic edge devices to perform a task using an edge computing ecosystem.

Edge computing is computing that is done at or near the source of the data, instead of relying on cloud computing at one or more data centers to perform the processing. Edge computing does not remove the need for cloud computing, rather it utilizes cloud computing and brings it closer to the actual geographic location of the edge computing devices. It brings computation and data storage closer to where data is generated, enabling better data control, reduced costs, faster insights and actions, and continuous operations.

During edge computation, the edge devices collaborate with each other to perform the computation (e.g., exchange data and information with each other). Edge computing may be performed at any geographic location, such as a manufacturing floor, smart house, disaster clean-up site, etc., where edge devices may be configured as various types of robotic devices (e.g., operating machines, robots, or any other mobile machines such as rile spot robots, etc.).

In many instances, edge devices require ultra-low latency in order to communicate with each other. For example, ultra-low latency 5G communications require hyper-localization, typically within 1,000 ft. While performing edge computation, the participating edge devices should be present within a communication range of each other, otherwise the edge devices will not be able to communicate with each other without undue latency, thus not allowing performance of edge computation. For different contextual situations, different robotic devices/machines need to participate in the edge computation to perform a task. However, latency issues may cause processing discontinuity from one or more edge devices/machines where the task is to be executed.

### SUMMARY

Embodiments of the present disclosure include a computer-implemented method, system, and computer program product for intelligently assigning robotic edge devices to perform a task using an edge computing ecosystem. A processor may identify a plurality of robotic edge devices in a geographic location. The processor may determine attributes for each robotic edge device of the plurality of robotic edge devices. The processor may identify a task to be performed at the geographic location by the plurality of robotic edge devices. The processor may determine, based on the attributes, a subset of robotic edge devices that are capable of completing the task. The processor may assign the subset of robotic edge devices to complete the task. The present method for assigning robotic edge devices to perform the task based on their various edge related attributes is advantageous over traditional task allocation methods that utilize manually controlled robotic devices and/or fail to account for specific edge device attributes.

In some embodiments, the determination of the subset of robotic edge devices may be based on one or more attributes such as physical capabilities of the robotic edge device, edge computation latency, edge communication range, and the geographic location of the given robotic device. This allows the processor to determine which robotic edge devices may be assigned to perform the task, based on their capabilities and/or given locations. For example, a certain task may require robotic edge devices to move in and out of a certain edge communication range from each other while completing the task at the geographic location. The processor may assign robotic edge devices that may operate properly within the edge communication range when completing the task, which may include performing edge computation and/or physical activities associated with completing the task in parallel or sequentially in an efficient manner. This is advantageous over traditional task assignment techniques that fail to assign tasks to robotic edge devices based on their communication range and/or latencies that may result in edge computation delays and/or task completion delays.

In some embodiments, the task may be a physical task that is determined from analyzing data input from one or more Internet of Things (IoT) devices. For example, the task may be a physical task (e.g., moving an object using robotic devices, constructing/deconstructing a structure, etc.) that is determined by artificial intelligence through analysis of data input from an IoT camera. This allows the processor to automatically identify tasks to be completed from data input from various IoT devices.

In some embodiments, the processor will initiate the subset of robotic edge devices to complete the task and continuously monitor the subset of robotic edge devices while completing the task. This allows the processor to determine if any issues may occur that would delay or disrupt performance of the task (e.g., delay in performance due to latency and/or edge computation discontinuity have occurred).

In some embodiments, the processor may determine a first robotic edge device of the subset of robotic edge devices is experiencing difficulty completing at least one step of the task and assign a second robotic edge device to complete the at least one step of the task. For example, if the first robotic edge device is experiencing computational latency issues when collaborating with another robotic edge device that is out of edge communication range, the processor may assign a second robotic edge device or new robotic edge device to aid the first robotic edge device in completing the step of the task. For example, a mobile robotic edge device may be assigned to move to an area in the geographic location within the edge communication range between the first and other robotic edge device(s) to allow edge communication to occur between all the robotic edge devices without disruption. This is advantageous over traditional edge computation activities that may experience delay due to latency issues when devices are out of edge communication range.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example robotic edge device assignment system, in accordance with some embodiments of the present disclosure.

FIG. 2 illustrates an example edge computing architecture, in accordance with embodiments of the present disclosure.

FIG. 3 illustrates an example diagram for assigning robotic edge devices to perform a task at a geographic location, in accordance with some embodiments of the present disclosure.

FIG. 4 illustrates an example process for intelligently assigning robotic edge devices to perform a task using an edge computing ecosystem, in accordance with some embodiments of the present disclosure.

FIG. 5 illustrates a high-level block diagram of an example computer system that may be used in implementing one or more of the methods, tools, and modules, and any related functions, described herein, in accordance with embodiments of the present disclosure.

FIG. 6 depicts a schematic diagram of a computing environment for executing program code related to the methods disclosed herein and for intelligent assignment of robotic edge devices, according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of robotic devices and, more particularly, to intelligently assigning robotic edge devices using an edge computing ecosystem. While the present disclosure is not necessarily limited to such applications, various aspects of the disclosure may be appreciated through a discussion of various examples using this context.

Edge computing is computing that is done at or near the source of the data, instead of relying on cloud computing at one or more data centers to perform the processing. Edge computing does not remove the need for cloud computing, rather it utilizes cloud computing and brings it closer to the actual geographic location of the edge computing devices. During edge computing, the edge devices are collaborating with each other to perform the computation. Edge computing may be performed at any geographic location, such as a manufacturing/assembly floor, smart house, disaster clean-up site, etc., where edge devices can be configured as various types of robotic devices.

Many edge devices require ultra-low latency in order to communicate with each other. While performing edge computation, the participating edge devices should present within range with each other, otherwise the edge devices will not be able to communicate with each other without undue latency, so they may not be able to perform edge computation. For different contextual situations, different robotic devices/machines need to participate in the edge computation to perform a task. However, latency issues may cause processing discontinuity from one or more edge devices/machines where the task is to be executed.

Embodiments of the present disclosure include a system, computer-implemented method, and computer program product that are configured to intelligently assign robotic edge devices to perform one or more tasks based on capabilities using an edge computing ecosystem. In embodiments, the robotic edge devices may perform physical activities along with participation in an ultra-low latency edge computation environment, so that both the physical activity and edge computing can be performed together by the assigned robotic edge devices.

In embodiments, the system may identify a plurality of robotic edge devices in a geographic location (zone, area, building, structure, road, etc.). The robotic edge devices may be any type of robotic edge device that can perform a task (e.g., physical task and/or computational task). The system may determine attributes for each robotic edge device of the plurality of robotic edge devices. The attributes may consist of various capabilities and or characteristics associated with the robotic edge device such as physical capabilities, edge computation latency, edge communication range, and the precise geographic location (e.g., using global position data, local position data, etc.) of each robotic edge device. For example, a first robotic edge device may have physical capabilities such as robotic limbs/extremities that allow the robotic edge device to pick up, move, and/or assemble various objects, while also having edge computation abilities that allow it to communicate (e.g., collect data/information) with other robotic edge devices to complete various tasks/functions.

In embodiments, the system may identify a task to be performed at the geographic location by one or more of the plurality of robotic edge devices. In embodiments, the task is determined by analyzing data input from one or more Internet of Things (IoT) devices. For example, the task may be determined by analyzing data input from one or more cameras and/or sensors that are positioned at the geographic location. In some embodiments, the task may be a physical task that requires the robotic edge devices to move/assemble/disassemble one or more objects in a sequence of steps at the geographic location. In some embodiments, the task may be a computational task (edge computation), in addition to a physical task.

In embodiments, the system may determine edge computation requirements for completing the task. For example, the edge computation requirements can be determined by assessing the sequence of steps required by the robotic edge devices to complete the task in a proper and effective way. For example, if the task is to remove debris (e.g., a fallen structure from an earthquake) from an area, the system may determine/predict the computation requirements of the robotic edge devices to perform the sequence of steps for removal of the debris in a proper, safe, and collaborative manner such that the debris does not collapse. In this way, the system may perform robotic edge device assignment by identifying ultra-low latency edge communication needs in any surrounding and/or geographic location.

In embodiments, the system may determine, based on the attributes, a subset of robotic edge devices that are capable of completing the task. For example, based on the identification of the task and the attributes associated with the plurality of robotic edge devices, the system will determine which robotic edge devices of the plurality of robotic edge devices are capable of performing the task in an efficient manner.

In embodiments, the system will assign the subset of robotic edge devices to complete the task. In some embodiments, the system may evaluate and/or predict the priority between edge computing and physical activities (based on relative position of the robotic edge devices, distance, timing and/or sequences of steps for completing the task, etc.) to identify which should be given priority and which should be performed in parallel or sequentially when completing the task. Based on computational requirements and physical task requirements, the system will dynamically place robotic edge devices in the geographic location so that the edge computing decision can be executed in a coordinated manner.

In some embodiments, while the robotic edge devices are assigned to perform physical activity and edge computing together, the system will assign an activity and/or communication range to the edge devices, so that the assigned robotic edge devices can perform physical activities within a defined range (500 ft, 1000 ft, etc.) and can also perform edge computation.

In some embodiments, the system will initiate the subset of robotic edge devices to complete the task and monitoring the subset of robotic edge devices while completing the task. In some embodiments, the system may determine a first robotic edge device of the subset of robotic edge devices is experiencing difficulty completing at least one step of the task and assign a second robotic edge device to complete the at least one step of the task. For example, if the first robotic edge device is experiencing computational latency issues when collaborating with another robotic edge device that is out of edge communication range, the processor may assign a second robotic edge device or new robotic edge device to aid the first robotic edge device in completing the step of the task. For example, a mobile robotic edge device may be assigned to move to an area in the geographic location within the edge communication range between the first and other robotic edge device(s) to allow edge communication to occur between all the robotic edge devices without disruption. In this way, the system may dynamically assign/reassign robotic edge devices to prevent delays in completing the task.

The aforementioned advantages are example advantages, and not all advantages are discussed. Furthermore, embodiments of the present disclosure can exist that contain all, some, or none of the aforementioned advantages while remaining within the spirit and scope of the present disclosure.

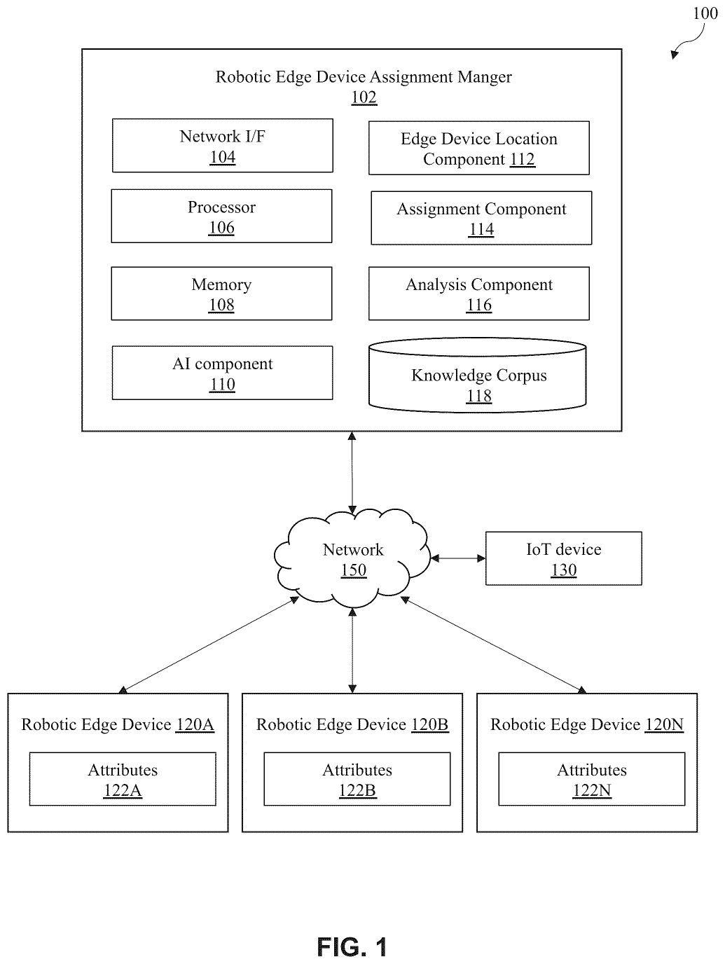

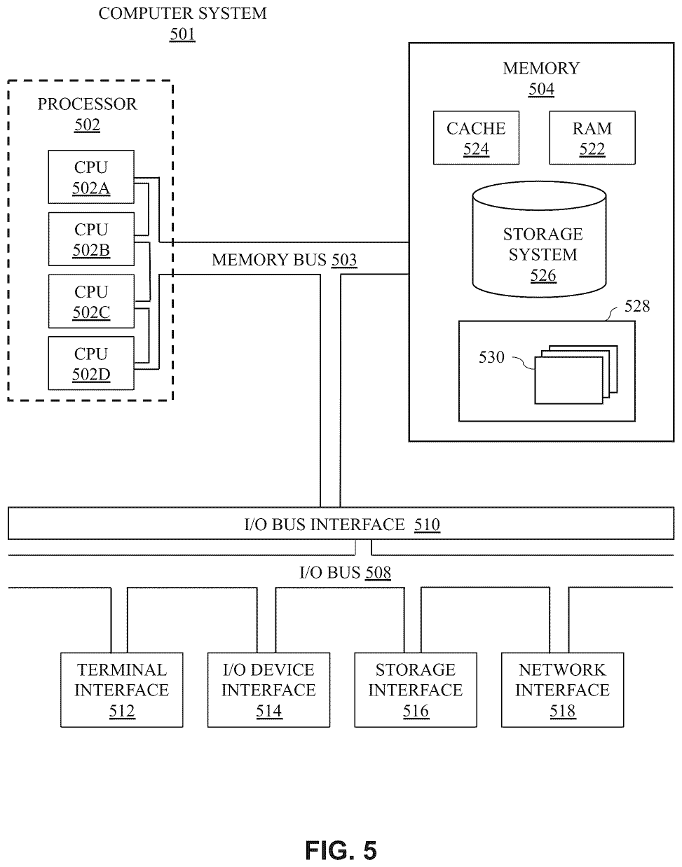

With reference now to FIG. 1, shown is a block diagram of an example robotic edge device assignment system 100 in which illustrative embodiments of the present disclosure may be implemented. In the illustrated embodiment, the robotic edge device assignment system 100 includes robotic edge device assignment manager 102 that is communicatively coupled to robotic edge device 120A, robotic edge device 120B, robotic edge device 120N (collectively referred to as robotic edge devices 120), and Internet of Things (IoT) device 130 via network 150. In embodiments, robotic edge device assignment manager 102, robotic edge devices 120, and IoT device 130 may be configured as any type of computer system and may be substantially similar to computer system 501 of FIG. 5.

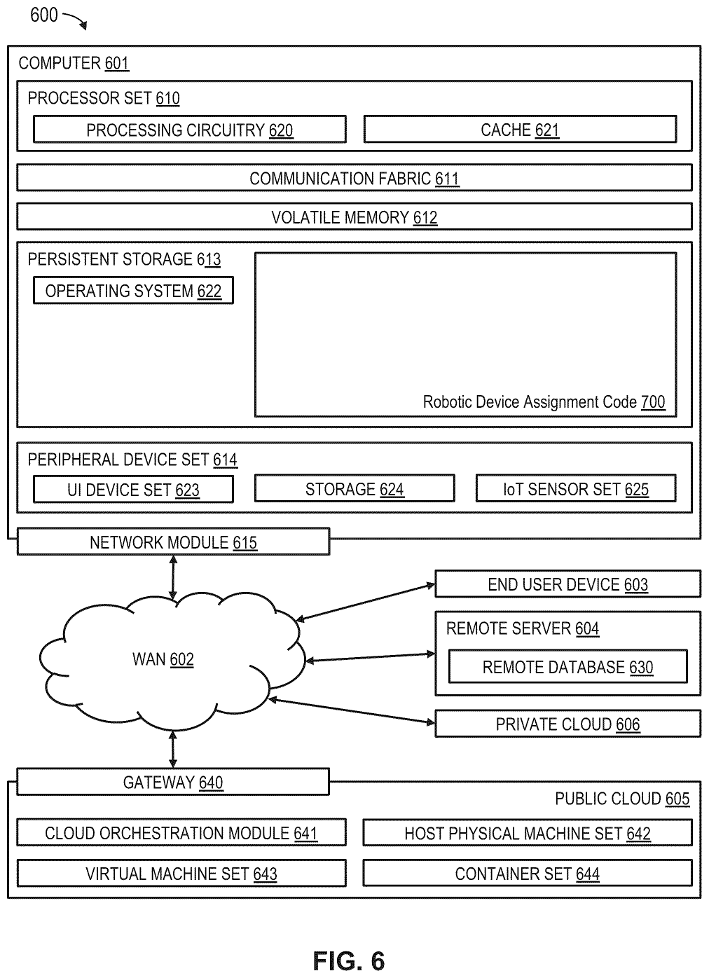

In embodiments, network 150 may be any type of communication network, such as a wireless network, edge computing network, a cloud computing network, or any combination thereof (e.g., hybrid cloud network/environment). Consistent with various embodiments, a cloud computing environment may include a network-based, distributed data processing system that provides one or more edge/network/cloud computing services. Further, a cloud computing environment may include many computers (e.g., hundreds or thousands of computers or more) disposed within one or more data centers and configured to share resources over network 150. In some embodiments, network 150 may be substantially similar to computing environment 600 of FIG. 6.

In some embodiments, network 150 can be implemented using any number of any suitable communications media. For example, the network may be a wide area network (WAN), a local area network (LAN), an internet, or an intranet. In certain embodiments, the various systems may be local to each other, and communicate via any appropriate local communication medium. For example, robotic edge device assignment manager 102 may communicate with robotic edge devices 120 and IoT device 130 using a WAN, one or more hardwire connections (e.g., an Ethernet cable), and/or wireless communication networks. In some embodiments, the various systems may be communicatively coupled using a combination of one or more networks and/or one or more local connections. For example, robotic edge device assignment manager 102 may communicate with IoT device 130 through a hardwired connection, while communication between robotic edge devices 120 may be through a wireless communication network.

In embodiments, robotic edge device assignment manager 102 includes processor 106 and memory 108. The robotic edge device assignment manager 102 may be configured to communicate with robotic edge devices 120 and IoT device 130 through an internal or external network interface 104. The network interface 104 may be, e.g., a modem or a network interface card. The robotic edge device assignment manager 102 may be equipped with a display or monitor. Additionally, the robotic edge device assignment manager 102 may include optional input devices (e.g., a keyboard, mouse, scanner, or other input device), and/or any commercially available or custom software (e.g., browser software, communications software, server software, natural language processing/understanding software, search engine and/or web crawling software, filter modules for filtering content based upon predefined parameters, etc.).

In embodiments, the robotic edge device assignment manager 102 may include artificial intelligence (AI) component 110, edge device location component 112, assignment component 114, analysis component 116, and knowledge corpus 118.

In embodiments, AI component 110 is configured to collect, analyze, and identify attributes 122 associated with each robotic edge device 120. The attributes 122 may include various capabilities of each of the respective robotic devices 120. Capabilities may include physical capabilities (e.g., robotic extremities capable of moving objects, movement capabilities, edge communication capabilities/range, edge processing capabilities, and the like) that can be correlated with performing different tasks. AI component 110 may utilize edge device location component 112 to determine precise location (e.g., using location data) and distances of robotic edge devices 120 in relation to each other and/or relation to the geographic location of the task to be performed. The AI component 110 may use the precise location and distances of the robotic edge devices 120 to determine which robotic edge devices are available within a given geographic location and if the robotic edge devices are within a communication range (based on attributes) such that edge computation/data communication can be performed.

In embodiments, AI component 110 may use analysis component 116 to determine requirements for performing a task at the geographic location. For example, the AI component 110 may analyze various data inputs and identify that a physical task may be required to be performed. The task may be identified by collecting and analyzing data input received from IoT device 130 (e.g., based on visual data, or sensor input). For example, the AI component 110 may analyze a data feed from an IoT camera located at the geographic location and determine/detect (e.g., using image recognition, computer vision techniques) that debris needs to be cleared by one or more robotic edge devices. The analysis component 116 may determine, based on the identified attributes 122 of the robotic edge devices 120, which robotic devices are capable of clearing the debris. The analysis component 116 may utilize knowledge corpus 118 to identify various attributes/capabilities associated with each of the robotic edge devices 120 and which attributes 122 are best for clearing debris based on historical data for performing similar tasks. Further, the AI component 110 may analyze and predict one or more steps required for completing the task and computation requirements for performing the steps. For example, the AI component 100 may determine a sequence of steps that are required to be performed by the robotic edge devices to complete the identified task. For example, the AI component 100 may predict which steps for cleaning the debris should be performed in order for the task to be performed in a safe manner (e.g., removing certain debris from a fallen structure to prevent collapse or damages from occurring). The sequence of steps may be communicated to the robotic edge devices 120 such that they collaborate with one another while sequentially completing the steps of the task.

In embodiments, the robotic edge device assignment manager 102 may utilize the assignment component 114 to assign the appropriate robotic edge devices 120, based on attributes, to perform the task at the identified geographic location. The AI component 110 may initiate completion of the task by the robotic edge devices 120. The analysis component 116 may continuously monitor edge data from the robotic edge devices 120 to determine if the task has been completed. In some embodiments, the analysis component 116 may determine one or more robotic devices are experiencing difficulty completing the task (e.g., loss of communication between robotic devices, idle movement of the robotic device, etc.) and reassign a new or different robotic device 120 to complete at least a portion or step of the task. For example, one or more robotic edge devices 120 may fail to perform various steps of a task due to communication range limitations. For example, edge computation/processing may fail to be performed because one or more robotic edge devices 120 have exceeded a communication range limit. The assignment component 114 can assign a new robotic edge device (e.g., mobile robot) to locate the robotic edge device having difficulty completing the task and provide assistance in completing the task. For example, the new robotic edge device may increase the communication range of the another robotic edge device by filling in a communication gap between two robotic edge devices.

In some embodiments, the assignment component 112 will further evaluate the priority between edge computing and physical activities (based on relative position, distance, timing etc.) performed by the robotic edge devices 120 to identify which one should be given priority vs. performed in parallel and assign them to different robotic edges devices within a defined range or zone in the geographic location. For example, the assignment component 114 may assign robotic edge device 120A to perform a physical activity that is out of edge communication range at a first step in the task, and once the first step is complete, assign the robotic edge device 120A to move within edge computation range to edge device 120B to initiate performance of a second step of the task. In this way, the first step of the task may not require edge computation in parallel with the physical activity and thus can be completed out of communication range. In this way, the robotic edge device assignment manager 102 dynamically assigns/places robotic edge devices in the surrounding so that the edge computing decision can be executed in a most efficient manner when completing the identified task.

In embodiments, knowledge corpus 118 may be used to store, access, and/or update data for making decisions related to assigning robotic devices to complete tasks at a geographic location. For example, AI component 110 may access various historical data related to robotic edge devices 120 performing similar historical tasks and use this information to determine which robotic edge devices are best to assign to a given task. For example, a first robotic edge device may perform physical tasks well (e.g., assembly tasks, object moving tasks, etc.) but have limited edge computation abilities (e.g., latency issues, short communication range, etc.). Therefore, the AI component 110 may not assign this robotic edge device to perform a task where a larger communication range is necessary for completing the edge computation in parallel with physical activities associated with the identified task.

In some embodiments, AI component 110 may use machine learning algorithms to improve its assignment capabilities automatically through experience and/or repetition without procedural programming. For example, the AI component 110 may analyze historic data related to performing various tasks using one or more robotic edge devices. The AI component 110 may analyze the performance of various robotic edge devices along with their attributes, and through repetition, improve efficiencies for assigning robotic edge devices for completing new tasks.

Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

It is noted that FIG. 1 is intended to depict the representative major components of an exemplary robotic edge device assignment 100. In some embodiments, however, individual components may have greater or lesser complexity than as represented in FIG. 1, components other than or in addition to those shown in FIG. 1 may be present, and the number, type, and configuration of such components may vary.

For example, while FIG. 1 illustrates a robotic edge device assignment system 100 with a single robotic edge device assignment manager 102, three robotic edge devices 120, a single IoT device 130, and a single network 150, suitable computing environments for implementing embodiments of this disclosure may include any number of robotic edge device assignment systems, robotic edge device assignment managers, robotic edge devices, IoT devices, and networks. The various modules, systems, and components illustrated in FIG. 1 may exist, if at all, across a plurality of robotic edge device assignment systems, robotic edge device assignment managers, robotic edge devices, IoT devices, and networks.

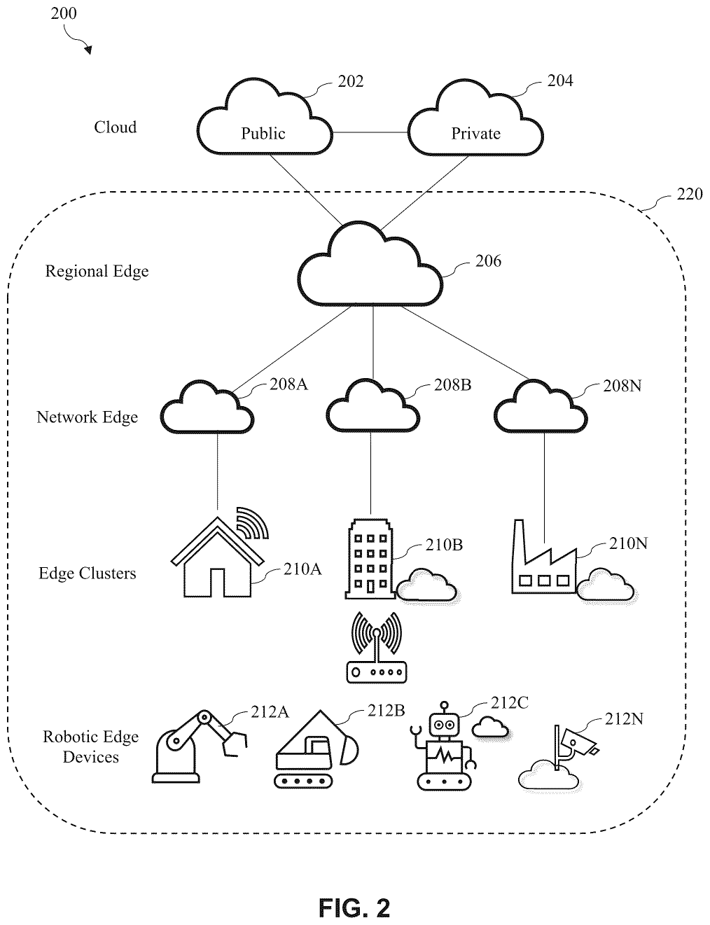

Referring now to FIG. 2, shown is an example edge computing architecture 200, in accordance with embodiments of the present disclosure. In the illustrated embodiment, public cloud 202 and private cloud 204 are communicatively connected to edge network topology 220. In embodiments, public cloud 202 and private cloud 204 may be substantially similar to computing environment 600 described in FIG. 6. In some embodiments, public cloud 202 and private cloud 204 may be linked such that they are collectively a hybrid cloud.

Edge network topology 220 illustrates the edge environment where robotic edge device assignment system 100 of FIG. 1 resides. In the illustrated embodiment, edge network topology 220 includes regional edge 206, network edge 208A, network edge 208B, network edge 208N (collectively referred to as network edges 208), edge cluster 210A, edge cluster 210B, edge cluster 210N (collectively referred to as edge clusters 210), robotic edge device 212A, robotic edge device 212B, robotic edge device 212C, and robotic edge device 212N (collectively referred to as robotic edge devices 212) that are communicatively connected to each other via a distributed computing network. In some embodiments, robotic edge device assignment manager 102 may be configured as regional edge 206, one of network edges 208, and/or one of edge clusters 210. In embodiments, robotic edge devices 120 may be configured as robotic edge devices 212. In embodiments, edge network topology 220 is configured to bring analytical computational resources closer to the geographic location of the given identified task and/or end users and therefore increase the responsiveness and throughput of applications and/or performance of the robotic edge devices 212. By bringing the computational resources closer to the geographic location of the task, specifically collaboration of computational data between the robotic edge devices related to performing the task, the use of the edge network topology 220 significantly outperforms a traditional cloud-based only system by reducing data access response times and management costs.

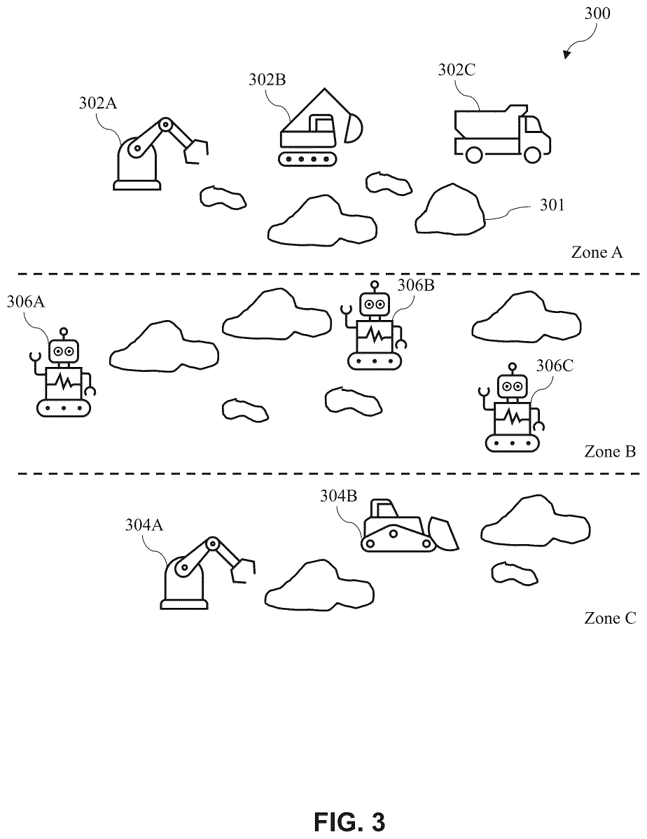

Referring now to FIG. 3, shown is an example diagram 300 for assigning robotic edge devices to perform a task at a geographic location, in accordance with some embodiments of the present disclosure. In the illustrated embodiment, the identified task to be performed at the geographic location is to clean up debris by utilizing a plurality of robotic edge devices. This task may be identified by the robotic edge device assignment manager by analyzing data input obtained from one or more IoT devices (not shown) within the geographic location. The robotic edge device assignment manager will utilize the data to determine the edge computing needs and/or physical requirements necessary for completing the task. For example, based on the identified debris, the robotic edge device assignment manager will determine the proper steps and/or sequence that the robotic edge devices need to follow to remove the debris in an efficient and proper manner. This determination may be performed using the AI component and based on historical data for performing similar tasks. For example, if a building collapsed, the robotic edge device assignment manager will identify the proper sequence to deconstruct the collapsed building using the robotic edge devices in a safe way.

In the illustrated embodiment, robotic edge device 302A, robotic edge device 302B, and robotic edge device 302C (collectively referred to as robotic edge device 302) are geographically positioned in zone A of the geographic location. Robotic edge device 304A, and robotic edge device 304B (collectively referred to as robotic edge device 304) are geographically positioned in zone C of the geographic location. Because there is significant debris between Zone A and Zone C, robotic edge devices 302 and robotic edge device 304 are not in close proximity (based on their given locations) to each other to adequately perform edge computation (based on edge latencies) in order to remove all of the debris 301 in an efficient manner (e.g., sequence determined by AI). Further, the size (large automated trucks/excavator) and movement capabilities (static robotic devices) may prevent the robotic edge devices 302 and 304 from coming in close enough proximity (edge communication range) to allow for proper edge computation. Therefore, robotic edge device assignment manager will analyze the relative positions (e.g., using global positioning and/or local position data) and attributes associated with all robotic edge devices in the geographic location and deploy additional robotic edge devices in order to complete the task.

For example, the relative distance between Zone A and Zone C may be 1500 ft, while the relative distance between Zone A and Zone B, and Zone B and Zone C may be within 750 ft. If robotic edge devices 302 and robotic edge devices 304 only have a communication range of 1000 ft for performing collaborative edge computation, then these robotic edge devices would be unable to adequately complete the task. Therefore, the robotic edge device assignment manager may assign additional robotic devices to close the gap in communication range. Further, the robotic edge device assignment manager may assign robotic edge devices that have a movement capability that allows the robotic edge device to move within the debris (e.g., smaller robotic edge devices such as reconnaissance robotic devices, smart unmanned ground vehicles, unmanned aerial vehicles, and the like) where larger robotic edge devices (robotic edge device 302 and 304) may not be able to navigate prior to completion of various steps of the task.

In the illustrated embodiment, robotic device assignment manger deploys robotic edge device 306A, robotic edge device 306B, and robotic edge device 306C (collectively referred to as robotic edge device 306) to Zone B of the geographic location. This allows edge computation and/or communication between robotic devices 302, robotic device 304, and robotic 306 to be performed within the communication range of the given devices, while further allowing the completion of the task (clearing debris) to be performed in an efficient manner.

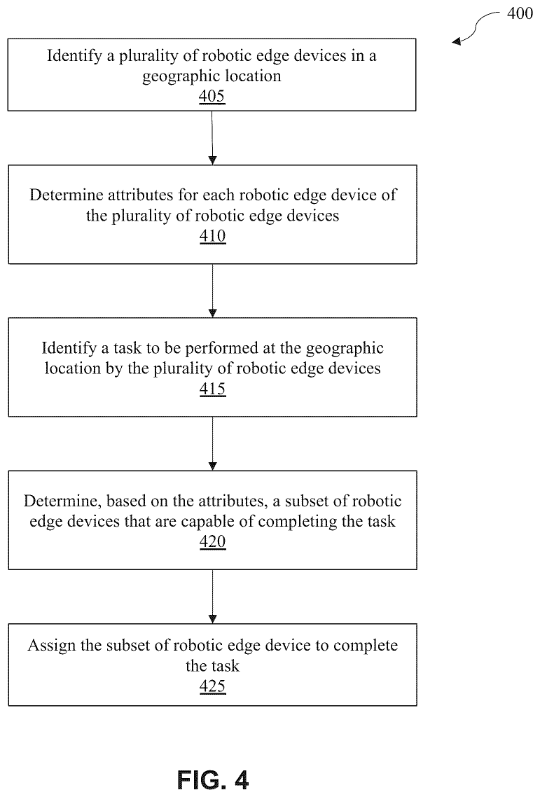

Referring now to FIG. 4, shown is an example process 400 for intelligently assigning robotic edge devices to perform a task using an edge computing ecosystem, in accordance with some embodiments of the present disclosure. The process 400 may be performed by processing logic that comprises hardware (e.g., circuitry, dedicated logic, programmable logic, microcode, etc.), software (e.g., instructions run on a processor), firmware, or a combination thereof. In some embodiments, the process 400 is a computer-implemented process. In embodiments, the process 400 may be performed by processor 106 of robotic edge device assignment manager 102 exemplified in FIG. 1.

In embodiments, the process 400 begins by identifying a plurality of robotic edge devices in a geographic location. This is illustrated at step 405. For example, the robotic device assignment manger may identify various robotic edge devices within various positions/zones of the geographic location using location data from the robotic edge devices. The robotic edge device(s) may be any type of robotic edge device that can perform a task (e.g., physical task and/or computational task). In some embodiments, the plurality of robotic edge devices may consist of one or more of a reconnaissance robotic device, a manufacturing robotic device, assembly robotic device, a debris clearing robotic device, an excavating robotic device, a smart vehicle, an unmanned ground vehicle, and an unmanned aerial vehicle.

The process 400 continues by determining attributes for each robotic edge device of the plurality of robotic edge devices. This is illustrated at step 410. In embodiments, the attributes may consist of various capabilities and or characteristics associated with the robotic edge device such as physical capabilities, edge computation latency, edge communication range, and the precise geographic location (e.g., using global position data, local position data, etc.) of each robotic edge device. For example, a first robotic edge device may have physical capabilities such as robotic limbs/extremities that allow the robotic edge device to pick up, move, and/or assemble various objects, while also having edge computation abilities that allow it to communicate (e.g., collect data/information) with other robotic edge devices to complete various tasks/functions.

The process 400 continues by identifying a task to be performed at the geographic location by the plurality of robotic edge devices. This is illustrated at step 415. In embodiments, the task is determined by analyzing data input from one or more Internet of Things (IoT) devices. For example, the task may be determined using one or more cameras and/or sensors to identify a task that needs to be completed. In some embodiments, the task may be a physical task that requires the robotic edge devices to move one or more objects in a sequence of steps at the geographic location. For example, visual input may be analyzed to identify that debris (e.g., collapsed building or traffic accident) needs to be cleared from a road/zone at the geographic location in a proper order. In another example, the task may be a manufacturing task such as assembling a vehicle, where various robotic edge devices perform one or more assembly steps of the task in a collaborative manner at a manufacturing facility. In some embodiments, the task may be a computational task (edge computation), in addition to a physical task.

In embodiments, the robotic device assignment manger will utilize an AI component which can be trained to assign robotic edge devices based on analyzing historical data generated when performing historic tasks. For example, based on assessing any physical surroundings at the geographic location, the robotic device assignment manger will be trained to identify what types of robotic edge devices are to be assigned to complete the task (e.g., earth removal machine, robots, forklift, manufacturing/assembly robots, etc.), and take into consideration the robotic edge devices' edge computing capabilities. The robotic device assignment manger will estimate the edge computing need based on the historical learning (e.g., previously assigned robotic edge devices have performed improper removing of debris that has caused collapses and/or accidents in the past).

The process 400 continues by determining, based on the attributes, a subset of robotic edge devices from the plurality of robotic edge devices that are capable of completing the task. This is illustrated at step 420. For example, based on the identification of the task and the attributes associated with the plurality of robotic edge devices, the robotic device assignment manger will determine which robotic edge devices are capable of performing the task. For example, if the task is determined to be earth/debris removal from the geographic location, the robotic device assignment manger will determine that various earth removal devices (e.g., robotic excavators, robotic trucks, etc.) having edge computational capabilities will be grouped together to perform the task. For example, robotic edge devices that can collaboratively determine the proper sequence of debris removal will be assigned to complete the task based on their capabilities. In this way, the proper subset of robotic edge devices will be assigned to perform and complete the task.

In embodiments, the edge computational needs will be identified based on the task. For example, the robotic device assignment manger will identify based on an area or size of the geographic location where the task is to be performed, what communication range capabilities are required for the subset of robotic edge devices. For example, if the task requires movement around the geographic location, the robotic device assignment manger will predict maximum movement distances within the zones of the geographic location between the robotic edges devices when performing the task. Using the predicated maximum movement distances the robotic device assignment manger may assign more or less robotic edge devices to perform the task based on their capabilities (e.g., latency, communication range, physical capabilities, location, etc.) and their assigned locations within the geographic location. For example, the system may assign more robotic edge devices to perform the task if the predicted movement distances for completing the task cause the robotic devices to go outside of their communication range capabilities when moving around zones of the geographic location.

The process 400 continues by assigning the subset of robotic edge device to complete the task. This is illustrated at step 425. In some embodiments, the process 400 further comprises initiating the subset of robotic edge devices to complete the task and monitoring the subset of robotic edge device while completing the task. In embodiments, the system will be identifying the relative position and location of each of the robotic edge devices within the geographic location. The system may monitor how the robotic edge devices are performing the activities and moving physically around the geographic location. Based on the change in the mobility of the robotic edge devices, the devices may/will be moving out from their ranges and will not be able to communicate with each other. Therefore, constant monitoring may be required to verify that steps of the given tasks are being completed.

For example, the processor may determine a first robotic edge device of the subset of robotic edge devices is experiencing difficulty completing at least one step of the task and assign a second robotic edge device to complete the at least one step of the task. For example, if the first robotic edge device is experiencing computational latency issues when collaborating with another robotic edge device that is out of edge communication range, the processor may assign a second robotic edge device or new robotic edge device to aid the first robotic edge device in completing the step of the task. For example, a mobile robotic edge device may be assigned to move to an area in the geographic location within the edge communication range between the first and other robotic edge device(s) to allow edge communication to occur between all the robotic edge devices without disruption. In this way, the proposed system will dynamically be deploying appropriate edge devices so that the edge computing decision transmission route can be created to efficiently complete the task.

Referring now to FIG. 5, shown is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache. In some embodiments, a processor can include at least one or more of, a memory controller, and/or storage controller. In some embodiments, the CPU can execute the processes included herein (e.g., process 400 as described in FIG. 4). In some embodiments, the computer system 501 may be configured as robotic device assignment system 100 of FIG. 1.

System memory subsystem 504 may include computer system readable media in the form of volatile memory, such as random-access memory (RAM) 522 or cache memory 524. Computer system 501 may further include other removable/non-removable, volatile/non-volatile computer system data storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 504 can include flash memory, e.g., a flash memory stick drive or a flash drive. Memory devices can be connected to memory bus 503 by one or more data media interfaces. The memory subsystem 504 may include at least one program product having a set (e.g., at least one) of program modules that are configured to carry out the functions of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single units, the computer system 501 may, in some embodiments, contain multiple I/O bus interfaces 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

One or more programs/utilities 528, each having at least one set of program modules 530 may be stored in memory subsystem 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 528 and/or program modules 530 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Embodiments of the present disclosure may be implemented together with virtually any type of computer, regardless of the platform is suitable for storing and/or executing program code. FIG. 6 shows, as an example, a computing environment 600 (e.g., cloud computing system) suitable for executing program code related to the methods disclosed herein and for circuit design automation. In some embodiments, the computing environment 600 may be the same as or an implementation of the computing environment 100.

Computing environment 600 contains an example of an environment for the execution of at least some of the computer code involved in performing the inventive methods, such as robotic edge device assignment code 700. The robotic edge device assignment code 700 may be a code-based implementation of the robotic device assignment system 100. In addition to robotic edge device assignment code 700, computing environment 600 includes, for example, a computer 601, a wide area network (WAN) 602, an end user device (EUD) 603, a remote server 604, a public cloud 605, and a private cloud 606. In this embodiment, the computer 601 includes a processor set 610 (including processing circuitry 620 and a cache 621), a communication fabric 611, a volatile memory 612, a persistent storage 613 (including operating a system 622 and the robotic edge device assignment code 700, as identified above), a peripheral device set 614 (including a user interface (UI) device set 623, storage 624, and an Internet of Things (IoT) sensor set 625), and a network module 615. The remote server 604 includes a remote database 630. The public cloud 605 includes a gateway 640, a cloud orchestration module 641, a host physical machine set 642, a virtual machine set 643, and a container set 644.

The computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 630. As is well understood in the art of computer technology, and depending upon the technology, performance of a computer-implemented method may be distributed among multiple computers and/or between multiple locations. On the other hand, in this presentation of the computing environment 600, detailed discussion is focused on a single computer, specifically the computer 601, to keep the presentation as simple as possible. The computer 601 may be located in a cloud, even though it is not shown in a cloud in FIG. 1. On the other hand, the computer 601 is not required to be in a cloud except to any extent as may be affirmatively indicated.

The processor set 610 includes one, or more, computer processors of any type now known or to be developed in the future. The processing circuitry 620 may be distributed over multiple packages, for example, multiple, coordinated integrated circuit chips. The processing circuitry 620 may implement multiple processor threads and/or multiple processor cores. The cache 621 is memory that is located in the processor chip package(s) and is typically used for data or code that should be available for rapid access by the threads or cores running on the processor set 610. Cache memories are typically organized into multiple levels depending upon relative proximity to the processing circuitry. Alternatively, some, or all, of the cache for the processor set may be located “off chip.” In some computing environments, the processor set 610 may be designed for working with qubits and performing quantum computing.

Computer readable program instructions are typically loaded onto the computer 601 to cause a series of operational steps to be performed by the processor set 610 of the computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 621 and the other storage media discussed below. The program instructions, and associated data, are accessed by the processor set 610 to control and direct performance of the inventive methods. In the computing environment 600, at least some of the instructions for performing the inventive methods may be stored in the robotic edge device assignment code 700 in the persistent storage 613.

The communication fabric 611 is the signal conduction path that allows the various components of the computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In the computer 601, the volatile memory 612 is located in a single package and is internal to the computer 601, but, alternatively or additionally, the volatile memory may be distributed over multiple packages and/or located externally with respect to the computer 601.

The persistent storage 613 is any form of non-volatile storage for computers that is now known or to be developed in the future. The non-volatility of this storage means that the stored data is maintained regardless of whether power is being supplied to the computer 601 and/or directly to the persistent storage 613. The persistent storage 613 may be a read only memory (ROM), but typically at least a portion of the persistent storage allows writing of data, deletion of data and re-writing of data. Some familiar forms of persistent storage include magnetic disks and solid state storage devices. The operating system 622 may take several forms, such as various known proprietary operating systems or open source Portable Operating System Interface-type operating systems that employ a kernel. The code included in the robotic edge device assignment code 700 typically includes at least some of the computer code involved in performing the inventive methods.

The peripheral device set 614 includes the set of peripheral devices of the computer 601. Data communication connections between the peripheral devices and the other components of the computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 623 may include components such as a display screen, speaker, microphone, wearable devices (such as goggles and smart watches), keyboard, mouse, printer, touchpad, game controllers, and haptic devices. The storage 624 is external storage, such as an external hard drive, or insertable storage, such as an SD card. The storage 624 may be persistent and/or volatile. In some embodiments, the storage 624 may take the form of a quantum computing storage device for storing data in the form of qubits. In embodiments where the computer 601 is required to have a large amount of storage (for example, where the computer 601 locally stores and manages a large database) then this storage may be provided by peripheral storage devices designed for storing very large amounts of data, such as a storage area network (SAN) that is shared by multiple, geographically distributed computers. The IoT sensor set 625 is made up of sensors that can be used in Internet of Things applications. For example, one sensor may be a thermometer and another sensor may be a motion detector.

The network module 615 is the collection of computer software, hardware, and firmware that allows the computer 601 to communicate with other computers through the WAN 602. The network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 615 are performed on the same physical hardware device. In other embodiments (for example, embodiments that utilize software-defined networking (SDN)), the control functions and the forwarding functions of the network module 615 are performed on physically separate devices, such that the control functions manage several different network hardware devices. Computer readable program instructions for performing the inventive methods can typically be downloaded to the computer 601 from an external computer or external storage device through a network adapter card or network interface included in the network module 615.

The WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 603 is any computer system that is used and controlled by an end user (for example, a customer of an enterprise that operates the computer 601), and may take any of the forms discussed above in connection with the computer 601. The EUD 603 typically receives helpful and useful data from the operations of the computer 601. For example, in a hypothetical case where the computer 601 is designed to provide a recommendation to an end user, this recommendation would typically be communicated from the network module 615 of the computer 601 through the WAN 602 to the EUD 603. In this way, the EUD 603 can display, or otherwise present, the recommendation to an end user. In some embodiments, the EUD 603 may be a client device, such as thin client, heavy client, mainframe computer, desktop computer and so on.

The remote server 604 is any computer system that serves at least some data and/or functionality to the computer 601. The remote server 604 may be controlled and used by the same entity that operates computer 601. The remote server 604 represents the machine(s) that collect and store helpful and useful data for use by other computers, such as the computer 601. For example, in a hypothetical case where the computer 601 is designed and programmed to provide a recommendation based on historical data, then this historical data may be provided to the computer 601 from the remote database 630 of the remote server 604.

The public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 605 is performed by the computer hardware and/or software of the cloud orchestration module 641. The computing resources provided by the public cloud 605 are typically implemented by virtual computing environments that run on various computers making up the computers of the host physical machine set 642, which is the universe of physical computers in and/or available to the public cloud 605. The virtual computing environments (VCEs) typically take the form of virtual machines from the virtual machine set 643 and/or containers from the container set 644. It is understood that these VCEs may be stored as images and may be transferred among and between the various physical machine hosts, either as images or after instantiation of the VCE. The cloud orchestration module 641 manages the transfer and storage of images, deploys new instantiations of VCEs and manages active instantiations of VCE deployments. The gateway 640 is the collection of computer software, hardware, and firmware that allows the public cloud 605 to communicate through the WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 606 is similar to the public cloud 605, except that the computing resources are only available for use by a single enterprise. While the private cloud 606 is depicted as being in communication with the WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 605 and the private cloud 606 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

In some embodiments, one or more of the operating system 622 and the robotic edge device assignment code 700 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying a plurality of robotic edge devices in a geographic location;
determining attributes for each robotic edge device of the plurality of robotic edge devices;
identifying a task to be performed at the geographic location by the plurality of robotic edge devices;
determining, based on the attributes, a subset of robotic edge devices that are capable of completing the task; and
assigning the subset of robotic edge devices to complete the task.

2. The computer-implemented method of claim 1, further comprising:
initiating the subset of robotic edge devices to complete the task; and
monitoring the subset of robotic edge devices while completing the task.

3. The computer-implemented method of claim 2, further comprising:
determining a first robotic edge device of the subset of robotic edge devices is experiencing difficulty completing at least one step of the task; and
assigning a second robotic edge device to complete the at least one step of the task.

4. The computer-implemented method of claim 3, wherein the second robotic edge device is a new robotic edge device.

5. The computer-implemented method of claim 1, wherein the attributes of each robotic edge device comprise one or more attributes selected from a group consisting of:
physical capabilities of the robotic edge device;
edge computation latency;
edge communication range; and
geographic location.

6. The computer-implemented method of claim 1, wherein each robotic edge device is selected from a group of robotic edge devices consisting of:
a reconnaissance robotic device;
a debris clearing robotic device;
an excavating robotic device;
a smart vehicle; and
an unmanned aerial vehicle.

7. The computer-implemented method of claim 1, wherein the task is determined by analyzing data input from one or more Internet of Things (IoT) devices.

8. The computer-implemented method of claim 7, wherein the one or more IoT devices is selected from a group of IoT devices consisting of: a camera, a sensor, a computer.

9. The computer-implemented method of claim 1, wherein the task is a physical task.

10. The computer-implemented method of claim 9, wherein the physical task requires the subset of robotic edge devices to move one or more objects at the geographic location using edge computation between each robotic edge device of the subset of robotic edge devices.

11. A system comprising:
a processor; and
a computer-readable storage medium communicatively coupled to the processor and storing program instructions which, when executed by the processor, cause the processor to perform a method comprising:
identifying a plurality of robotic edge devices in a geographic location;
determining attributes for each robotic edge device of the plurality of robotic edge devices;
identifying a task to be performed at the geographic location by the plurality of robotic edge devices;
determining, based on the attributes, a subset of robotic edge devices that are capable of completing the task; and
assigning the subset of robotic edge devices to complete the task.

12. The system of claim 11, wherein the method performed by the processor further comprises:
initiating the subset of robotic edge devices to complete the task; and
monitoring the subset of robotic edge devices while completing the task.

13. The system of claim 12, wherein the method performed by the processor further comprises:
determining a first robotic edge device of the subset of robotic edge devices is experiencing difficulty completing at least one step of the task; and
assigning a second robotic edge device to complete the at least one step of the task.

14. The system of claim 11, wherein the attributes of each robotic edge device comprise one or more attributes selected from a group consisting of:
physical capabilities of the robotic edge device;
edge computation latency;
edge communication range; and
geographic location.

15. The system of claim 11, wherein each robotic edge device is selected from a group of robotic edge devices consisting of:
a reconnaissance robotic device;
a debris clearing robotic device;
an excavating robotic device;
a smart vehicle; and
an unmanned aerial vehicle.

16. A computer program product comprising a computer-readable storage medium having program instructions embodied therewith, the program instructions executable by a processor to cause the processor to perform a method comprising:
identifying a plurality of robotic edge devices in a geographic location;
determining attributes for each robotic edge device of the plurality of robotic edge devices;
identifying a task to be performed at the geographic location by the plurality of robotic edge devices;
determining, based on the attributes, a subset of robotic edge devices that are capable of completing the task; and
assigning the subset of robotic edge devices to complete the task.

17. The computer program product of claim 16, wherein the method performed by the processor further comprises:
initiating the subset of robotic edge devices to complete the task; and
monitoring the subset of robotic edge devices while completing the task.

18. The computer program product of claim 17, wherein the method performed by the processor further comprises:
determining a first robotic edge device of the subset of robotic edge devices is experiencing difficulty completing at least one step of the task; and
assigning a second robotic edge device to complete the at least one step of the task.

19. The computer program product of claim 16, wherein the attributes of each robotic edge device comprise one or more attributes selected from a group consisting of:
physical capabilities of the robotic edge device;
edge computation latency;
edge communication range; and
geographic location.

20. The computer program product of claim 16, wherein each robotic edge device is selected from a group of robotic edge devices consisting of:
a reconnaissance robotic device;
a debris clearing robotic device;
an excavating robotic device;
a smart vehicle; and
an unmanned aerial vehicle.
